(19) United States
(12) Patent Application Publication
(10) Pub. No.: US 2007/0266961 A1
(43) Pub. Date: Nov. 22, 2007

(54) Method for training a male dog

(76) Inventor: Stephanie Grace Johnson, Fullerton, CA (US)

Correspondence Address: LAW OFFICES OF ERIC KARICH, 2807 ST. MARK DR., MANSFIELD, TX, 76063, US

(21) Appl. No.: 11/438,492

(22) Filed: May 22, 2006

(51) Int. Cl. A01K 15/04

(52) U.S. Cl. 119/817

(57) ABSTRACT

A method for training a male dog not to lift its leg and urinate in a house by restricting movement of the dog's rear legs includes the steps of first providing a hobble having a pair of cuffs connected by a lateral connector. Each of the pair of cuffs is attached to one of the dog's rear legs when the dog is let into the house; and the length of the lateral connector is adjusted such that the length is great enough to allow the dog to walk, but small enough to prevent the dog from raising either of the rear legs.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to pet training methods, and more particularly to a method for training a male dog not to lift its rear leg to urinate on an object, the method using a hobble adapted to restrain the movement of the dog's rear legs.

2. Description of Related Art

Animal hobbles, used to restrict the movement of an animal's legs, are well known in the art. Such hobbles are typically attached to the front legs of the animal to restrict its running, jumping, and similar movement. Various forms of an animal hobble (or “hopple”) are shown in Brent, U.S. 115,691, Farrow, U.S. 914,257, Madsen, U.S. Pat. No. 4,934,321, and Rockhold, U.S. Pat. No. 5,092,276.

Other prior art devices include Flynt, U.S. Pat. No. 3,994,264, which teaches a harness for a dog for preventing the dog from jumping. The harness comprises a loop to be fitted around the dog's neck and having a strap extending under the dog to two loop-shaped straps to be fitted around the hind legs. A strap is connected to each of the loop-shaped straps and extends over the dog's hind quarters for holding the two loop-shaped straps high around the dog's hind legs. The dog's rear legs are not connected together, however, and there is no indication that the device can be used to teach the dog not to urinate in a house. Related devices include Moyle, U.S. Pat. No. 2,534,727, Sala Prat, et al., U.S. Pat. No. 6,513,461, and Kreutzer, U.S. 2003/0033989.

The above-described references are hereby incorporated by reference in full.

The prior art teaches various animal hobbles. However, the prior art does not teach the use of a hobble to connect the rear legs of a male dog. The present invention fulfills these needs and provides further related advantages as described in the following summary.

### SUMMARY OF THE INVENTION

The present invention teaches certain benefits in construction and use which give rise to the objectives described below.

The present invention provides a method for training a male dog not to urinate in a house by restricting movement of the dog's rear legs. The method comprises the steps of first providing a hobble having a pair of cuffs connected by a lateral connector. Each of the pair of cuffs is attached to one of the dog's rear legs when the dog is let into the house; and the length of the lateral connector is adjusted such that the length is great enough to allow the dog to walk, but small enough to prevent the dog from raising either of the rear legs.

A primary objective of the present invention is to provide a method for training a male dog having advantages not taught by the prior art.

Another objective is to provide a natural method for training a male dog to not lift his leg and urinate in a house by simply restricting the movement of the dog's rear legs, without otherwise substantially encumbering the natural movement of the dog.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is an perspective view of a hobble used in one embodiment of the present invention; and

FIG. 2 is a rear perspective view of a dog wearing the hobble.

### DETAILED DESCRIPTION OF THE INVENTION

The above-described drawing figures illustrate the invention, a method for training a male dog 10 not to lift its leg to urinate in a house by restricting movement of the dog's rear legs 12. The method includes the step of first providing a hobble 20 for restricting the movement of the dog's rear legs 12. The hobble 20 is used to prevent the male dog 10 from raising one of the rear legs 12 for urinating on furniture. When the male dog 10 is unable to raise its rear leg 12 and “mark its territory”, the dog 10 instead restrains himself from urinating until the need becomes urgent, typically after about 4 hours.

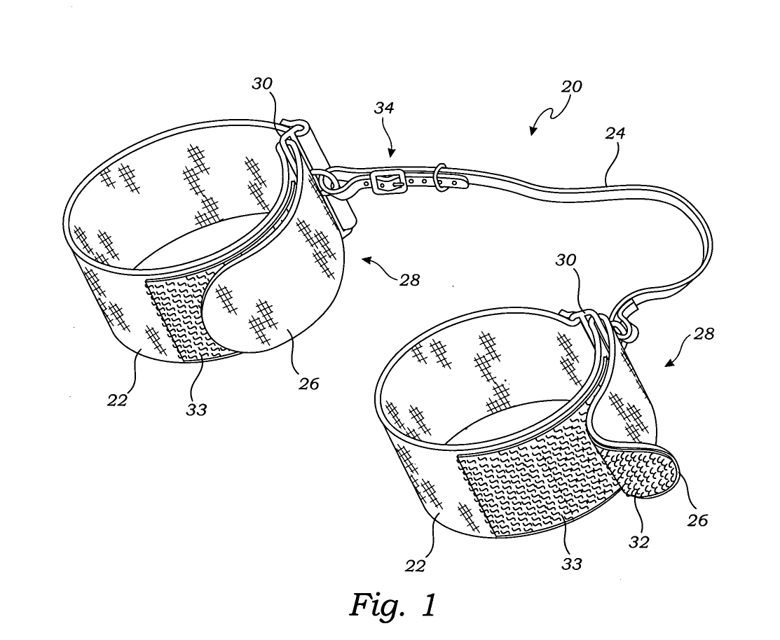

As shown in FIG. 1, the hobble 20 preferably includes a pair of cuffs 22 connected by a lateral connector 24. Each of the pair of cuffs 22 is preferably a flexible strap that includes a terminal end 26 that is threaded through a cuff adjustment mechanism 28. In one embodiment, the cuff adjustment mechanism 28 includes a slot 30 adapted to receive the terminal end 26, and the terminal end 26 preferably includes a hooks and loops attachment material 32 such as VELCRO® for facilitating adjustment to a mating material 33 on each of the pair of cuffs 22. Other forms of cuff adjustment mechanism 28 may also be used, such as a buckle, a snap, a chain with removable links, or any other method or apparatus known to those skilled in the art.

In addition to the flexible strap illustrated, the cuffs 22 could also be formed by an elastic loop, or other form of cuff capable of comfortably binding the rear legs 12 of the dog 10. Various alternatives are also described in the prior art, and such alternatives and other alternatives known to those skilled in the art should be considered within the scope of the invention, as claimed.

The lateral connector 24 is adapted to restrict the movement of the rear legs 12 of the dog 10 so that the dog 10 cannot raise its leg 12 for urination. The lateral connector 24 may be any form of strap, chain, or similar element for restricting movement, and preferably includes a connector adjustment mechanism 34 that functions to adjust the length of the lateral connector 24 so that the length of the connector adjustment mechanism 34 is suitable for the dog 10 being trained.

As with the cuff adjustment mechanism 28, the connector adjustment mechanism 34 may be any number of mechanisms, including a buckle, as shown in FIG. 1. In alternative embodiments, the connector adjustment mechanism 34 may be VELCRO®, snaps, or any other equivalent mechanism known to those skilled in the art.

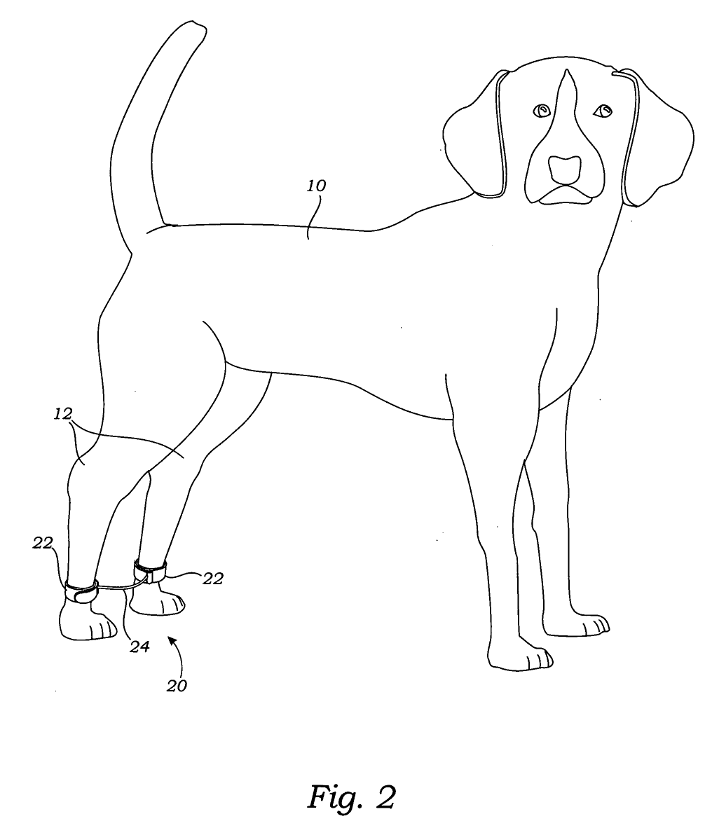

As shown in FIG. 2, each of the pair of cuffs 22 is attached to a lower portion of one of the dog's rear legs 12 when the dog 10 is let into the house; and the length of the lateral connector 24 is adjusted such that the length is great enough to allow the dog 10 to walk, but small enough to prevent the dog 10 from raising either of it's rear legs 12 for urinating.

The hobble 20 is then removed when the dog 10 exits the house, to allow the dog 10 to urinate in a natural manner. This should be done about every four hours, to prevent undue discomfort for the dog 10.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for training a male dog not to lift its rear leg and urinate in a house by restricting movement of the dog's rear legs, the method comprising the steps of:
providing a hobble having a pair of cuffs connected by a lateral connector;
attaching each of the pair of cuffs to one of the dog's rear legs when the dog is let into the house; and
adjusting the length of the lateral connector such that the length is great enough to allow the dog to walk, but small enough to prevent the dog from raising either of the rear legs.

2. The method of claim 1 further comprising the step of:
removing the hobble when the dog exits the house.

3. The method of claim 2, wherein the dog is allowed to exit the house at least about every four hours, so that the hobble may be removed and the dog may urinate in a natural manner.

4. The method of claim 1, wherein the hobble includes a connector adjustment mechanism.

5. The method of claim 1, wherein the hobble includes a cuff adjustment mechanism.

6. The method of claim 5, wherein each of the pair of cuffs is formed for a flexible strap, and wherein the cuff adjustment mechanism includes a hooks and loops attachment material attached to a terminal end of the flexible strap of each of the pair of cuffs.
